(19) United States
(12) Patent Application Publication
(10) Pub. No.: US 2009/0177816 A1
(43) Pub. Date: Jul. 9, 2009

(54) METHOD AND SYSTEM FOR COMMUNICATION WITH SD MEMORY AND SDIO DEVICES

(76) Inventors: Gerald Marx, San Diego, CA (US); Jun Guo, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/969,367

(22) Filed: Jan. 4, 2008

(51) Int. Cl. G06F 13/12

(52) U.S. Cl. 710/72

(57) ABSTRACT

The disclosed systems and methods relate to a reduction of system complexity by incorporating a clock cut-off signal in an SDIO device in order to support a multi-drop architecture. Aspects of the present invention enable a multi-drop architecture with an SDIO device and multiple SD memory devices sharing the same SD bus. Aspects of the present invention may also reduce host complexity by enabling a single host to control an SD device and multiple SD memory cards.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Secure Digital (SD) is a type of non-volatile (i.e. flash) memory card format developed for use in portable devices, including digital cameras, handheld computers, PDAs and GPS units. For example, an SD memory card may be used by a digital camera to store and retrieve photos. The portable device, also referred to as a host, writes and reads data to and from the SD memory card where the impetus for the reading comes only from the host and not from the SD memory card.

A related technology is SDIO. SDIO stands for Secure Digital Input Output. It is an interface that manages data transfer between a device and its host. In contrast to an SD memory card, an SDIO device needs to indicate to the host via an interrupt signal that it has data for the host to read. The host of an SDIO device does not read data from the SDIO device without the interrupt indication. The host of the SDIO device may write to the device much like it writes to a SD memory card. The SDIO and SD standards are published by the SD Card Association (SDCA).

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for allowing SD memory and SDIO devices to share a common SD bus as shown in and/or described in connection with at least one of the figures, as set forth more completely in the claims. Advantages, aspects and novel features of the present invention, as well as details of an illustrated embodiment thereof, will be more fully understood from the following description and drawings.

### BRIEF DESCRIPTION OF THE DRAWINGS

FIG. 1 is a block diagram that illustrates a multi-drop scenario with multiple host controllers;

FIG. 2 is a block diagram that illustrates a multi-drop scenario that requires a multiplexer;

FIG. 3 is a block diagram that illustrates a multi-drop scenario in accordance with a representative embodiment of the present invention;

FIG. 4 is a flow diagram that illustrates a method for communicating data from an SD memory card to an SDIO device in accordance with a representative embodiment of the present invention; and

FIG. 5 is a flow diagram that illustrates a method for communicating data from an SDIO device to an SD memory card in accordance with a representative embodiment of the present invention.

### DETAILED DESCRIPTION OF THE INVENTION

Aspects of the present invention relate to a reduction of system complexity by incorporating a clock cut-off signal in an SDIO device in order to support a multi-drop architecture. Aspects of the present invention enable a multi-drop architecture with an SDIO device and multiple SD memory devices sharing the same SD bus. Aspects of the present invention may also reduce host complexity by enabling a single host to control an SD device and multiple SD memory cards.

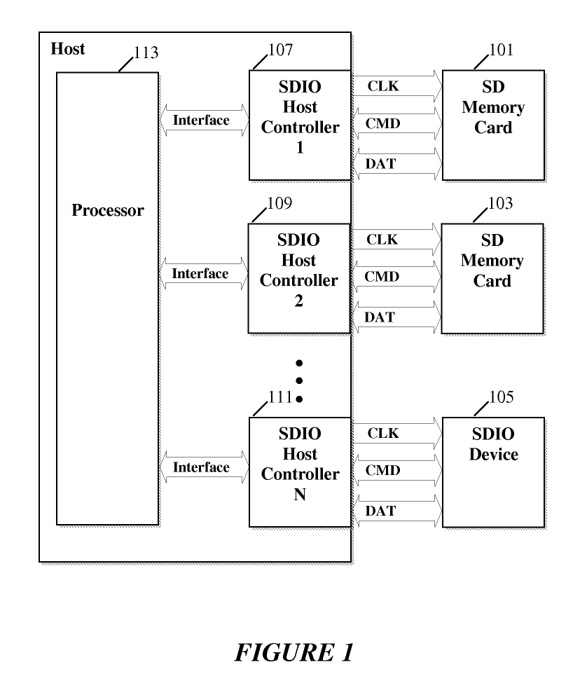

FIG. 1 is a block diagram that illustrates a first multi-drop scenario where each SD memory card (101 and 103) and SDIO device (105) is connected to a separate host controller (107, 109, and 111). This connection includes an SD clock line (CLK), an SD command line (CMD), and four SD data lines (DAT). Therefore, N CLK signals and N bidirectional buses (comprising the CMD and DAT signals) are used.

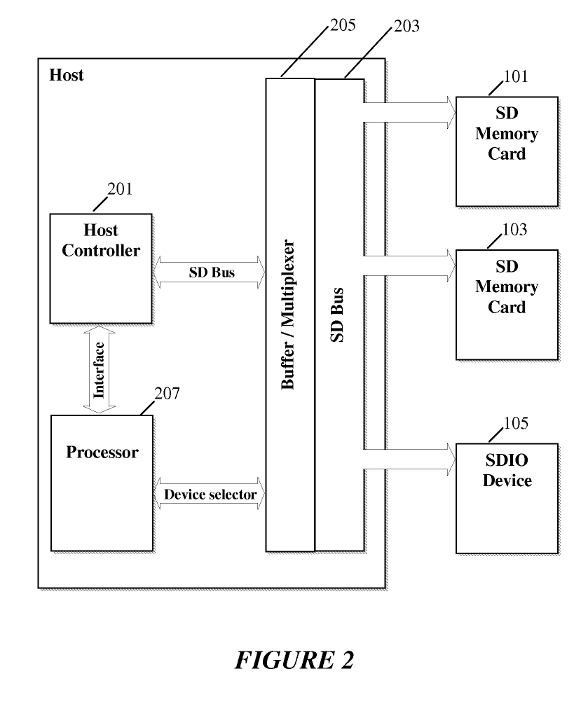

FIG. 2 is a block diagram that illustrates a multi-drop scenario with a single SDIO host controller (201), a single shared bus (203), and a buffer/multiplexer (205). The buffer/multiplexer (205) may be controlled by host firmware.

In the multi-drop scenario of FIG. 2, each SD memory card (101 and 103) and SDIO device (105) is connected to a single host controller (201) via the SD Bus (203) which may selectively (205) enable communication in a serial manner. The SD Bus includes an SD clock line (CLK), an SD command line (CMD), and an SD data line (DAT). The Processor (207) selects one device or memory card which may communicate with host controller (201). Therefore, the Buffer/Multiplexer (205) synchronizes the control and data communication. Communication the falls outside of the device selector timing may be buffered.

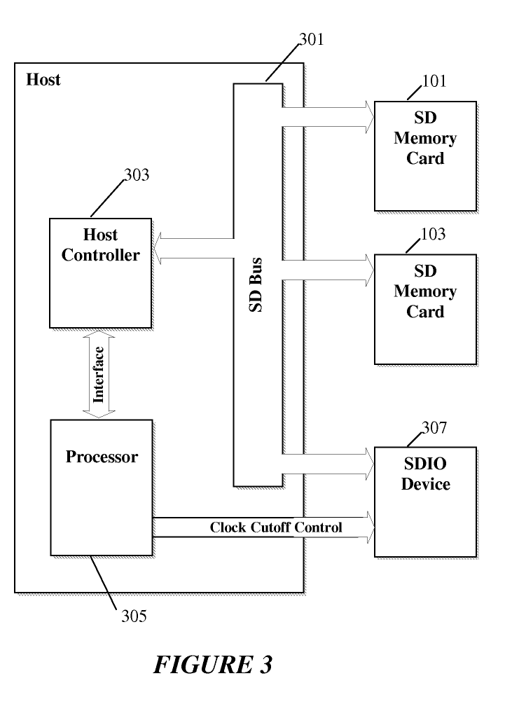

FIG. 3 is a block diagram that illustrates a multi-drop scenario in accordance with a representative embodiment of the present invention. The system in FIG. 3 comprises a single SDIO host controller (303) and single shared bus (301).

In the multi-drop scenario of FIG. 3, each SD memory card (101 and 103) and SDIO device (307) is connected to a single host controller (303) via the SD Bus (301) which does not require a multiplexer for synchronization.

The multi-drop system in FIG. 3 may share signals between devices via the SD Bus (301). Data is clocked in and out of the SD memory cards (101 and 103) and the SDIO device (307) over four data lines (DAT) and a command line (CMD) using a host supplied clock (CLK). The command line indicates which device is being addressed.

The host supplied clock to the SDIO device (307) may be cut off by the Processor (305) by using the clock cut-off control signal. The SDIO device (307) may provide a clock cut-off input through, for example, a GPIO (general purpose input/output). Invoking the clock cutoff control signal may also reduce the power consumption of the SDIO device (307).

Aspects of the multi-drop system may support an embedded SDIO device (307) with wireless data transmission capabilities, for example. The wireless device may use the SDIO transport, and the SD memory cards (101 and 103) may be plugged into an SD memory slot. The wireless device may be a Bluetooth device or wireless local area network (WLAN) device.

A user may, for example, plug a memory card, which contains music data, into of a multi-drop system. The wireless SDIO device may interface to a host via its SDIO interface. The music data may be transferred from the SD memory card to the host and then from the host to the wireless SDIO device via the device's SDIO interface. The embedded wireless SDIO device may then send the music data to a wireless headset.

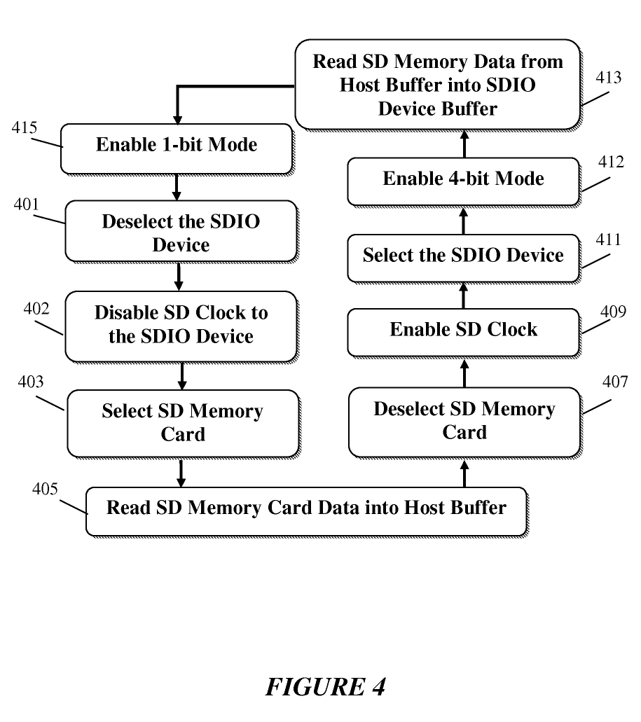

FIG. 4 is a flow diagram that illustrates a method for communicating data from an SD memory card to an SDIO device in accordance with a representative embodiment of the present invention.

The SDIO device is deselected at 401. At 402 the clock is cut off. Disabling the clock will prevent any commands, which are sent on the CMD line, from corrupting the SDIO device. For example, commands may be sent to the SD memory card or data may be transferred between the host and SD memory card without corrupting the SDIO device.

Disabling the clock may also reduce current consumption in the SDIO device during the time that the device sleeps. Such a device may be placed in 1-bit mode at 415 before it is granted permission to sleep by the host.

For example, if a host was reading picture data from a memory card to display on a screen in a multi-drop scenario, it may grant the SDIO device permission to sleep, then deselect the device, 401, via CMD7, and then cutoff its clock, 402. The clock may be cutoff by asserting a signal at a device input such as a GPIO input. The host could then safely read the picture data from the SD memory card, 405, without affecting the state of the SDIO device.

At 403, an SD memory card may be selected. This selection may be made by a host issued command, such as CMD7 on SDIO_CMD.

At 405, data on the selected SD memory card may be read into a host buffer. Following the data read, the SD memory card may be deselected at 407.

If the host wishes to send an SDIO command to a sleeping SDIO device, it would need to reenable the SD Clock at 409. This reenabling may be accomplished by removing the asserted signal, thereby causing CLK to be sourced to the SDIO device.

After the SDIO device is selected at 411, the SD memory card data may be read from the host buffer into an SDIO device buffer at 413.

When the SDIO device is selected, 411, 1-bit mode may be enabled, 415. Prior to reading data from the host buffer into an SDIO device buffer 413, 4-bit mode may be enabled, 412. In 1-bit mode, only data line D0 may be used for data, and D1 is dedicated as an interrupt line. In 4-bit mode, data lines D1, D2, and D3 may also be used for data, and D1 serves a dual use as an interrupt line and a data transfer line. Having D1 be 100% dedicated as an interrupt line when SDIO device transfer is completed is a preferred method.

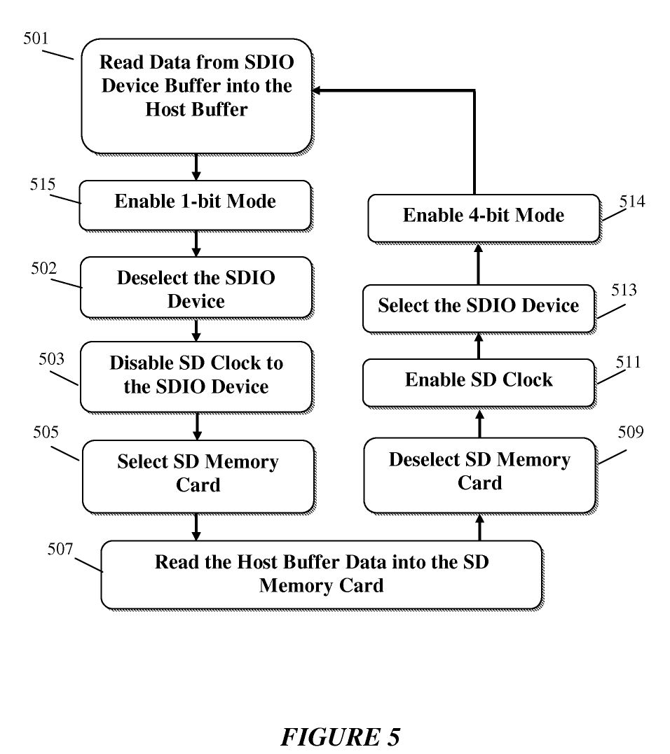

FIG. 5 is a flow diagram that illustrates a method for communicating data from an SDIO device to an SD memory card in accordance with a representative embodiment of the present invention.

At 501, data may be read from an SDIO device buffer into a host buffer.

When the SDIO device is deselected, 502, 1-bit mode may be enabled, 515. The host may periodically poll D1 line for an interrupt signal which indicates that data is available from the SDIO device. Alternatively, D1 may also be routed to a host input to generate an interrupt for the host software to process. In 1-bit data transfer mode, D1 serves as a dedicated interrupt source. In 4-bit data transfer mode, D1 is uses for both data transfer and as an interrupt source in a time multiplexed fashion.

At 503, the SD Clock to the SDIO Device may be disabled. This disable signal may use a GPIO input of the SDIO device.

At 505, an SD memory card may be selected. This selection may be made by the host issuing a command such as a CMD7 command.

At 507, data in the host buffer may be read into the selected SD memory card. Following the data read, the SD memory card may be deselected at 509.

In response to an interrupt from the SDIO device, the host may enable the SD clock. When the SD clock is enabled at 511, the SDIO device may be reselected at 513 by having the host issue a command such as the CMD7 command.

After selecting the SDIO device at 513, 4-bit mode may be enabled at 514 to allow data lines D1, D2, and D3 to be used for data.

The present invention may be realized in hardware, software, or a combination of hardware and software. The present invention may be realized in a centralized fashion in an integrated circuit or in a distributed fashion where different elements are spread across several circuits. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for communicating with a Secure Data Input/Output (SDIO) device and a Secure Data (SD) memory, wherein the system comprises:
an SD bus;
an SDIO host controller for communicating data, via the SD bus, with at least one of the SDIO device and the SD memory; and
a processor for enabling and disabling a clock signal to the SDIO device.

2. The system of claim 1, wherein the SD bus comprises a command line, a clock line, and four data lines.

3. The system of claim 2, wherein a signal on the command line indicates one of the SDIO device and the SD memory.

4. The system of claim 1, wherein the processor is connected to a General Purpose Input/Output (GPIO) for enabling and disabling the clock signal to the SDIO device.

5. The system of claim 1, wherein the SDIO device is a wireless device.

6. The system of claim 5, wherein the SDIO host controller receives an interrupt from the wireless device when data is available.

7. The system of claim 5, wherein the wireless device is a Bluetooth device.

8. The system of claim 5, wherein the wireless device is a wireless local area network device.

9. A method for communicating with a Secure Data Input/Output (SDIO) device and a Secure Data (SD) memory, wherein the method comprises:
deselecting the SDIO device;
disabling a clock to the SDIO device;
selecting the SD memory;
reading data from the selected SD memory into a host buffer;
deselecting the SD memory card;
enabling the clock to the SDIO device; and
selecting the SDIO device.

10. The method of claim 9, wherein a 1-bit mode is enabled prior to deselecting the SDIO device.

11. The method of claim 9, wherein a 4-bit mode is enabled after to selecting the SDIO device.

12. The method of claim 9, wherein the clock to the SDIO device is enabled and disabled via a GPIO input to the SDIO device.

13. The method of claim 9, wherein the SDIO device is a wireless device.

14. The method of claim 13, wherein the wireless device is a Bluetooth device.

15. The method of claim 13, wherein the wireless device is a wireless local area network device.

16. The method of claim 9, wherein the SD memory is selected via a signal on the command line.

17. The method of claim 9, wherein the data from the SD memory is read from the host buffer into an SDIO device buffer.

18. A method for communicating with a Secure Data Input/Output (SDIO) device and a Secure Data (SD) memory, wherein the method comprises:
reading data from the SDIO device into a host buffer;
deselecting the SDIO device;
disabling a clock to the SDIO device;
selecting the SD memory;
reading data from the host buffer into the selected SD memory;
deselecting the SD memory card; and
enabling the clock to the SDIO device.

19. The method of claim 18, wherein the clock to the SDIO device is enabled and disabled via a GPIO input.

20. The method of claim 18, wherein a host receives an interrupt from the SDIO device when data is available.

21. The method of claim 18, wherein the SDIO device is a wireless device.

22. The method of claim 21, wherein the wireless device is a Bluetooth device.

23. The method of claim 21, wherein the wireless device is a wireless local area network device.

24. The method of claim 18, wherein the SD memory is selected via a signal issued by a host.

25. The method of claim 18, wherein a 1-bit mode is enabled while the SDIO device is deselected.
